(19) United States
(12) Patent Application Publication
(10) Pub. No.: US 2022/0398590 A1
(43) Pub. Date: Dec. 15, 2022

(54) PAYMENT VERIFICATION METHOD AND PAYMENT VERIFICATION SYSTEM

(71) Applicants: INVENTEC APPLIANCES (PUDONG) CORPORATION, Shanghai (CN); INVENTEC APPLIANCES CORPORATION, New Taipei City (TW); INVENTEC APPLIANCES (SHANGHAI) CO. LTD., Shanghai (CN)

(72) Inventor: Li Yu, Shanghai (CN)

(21) Appl. No.: 17/554,349

(22) Filed: Dec. 17, 2021

(30) Foreign Application Priority Data
Jun. 15, 2021 (CN) 202110662922.9

(51) Int. Cl. G06Q 20/40; G06Q 20/32; G10L 15/22; G10L 15/30

(52) U.S. Cl. CPC G06Q 20/40145; G06Q 20/405; G06Q 20/3278; G10L 15/22; G10L 15/30

(57) ABSTRACT

A payment verification method, a payment verification system, a payment verification electronic device, and a payment verification storage medium are provided. The payment verification method includes: monitoring a voice command received by a radio device of a earphone when a payment channel between the earphone and a paired payment device is opened; extracting a voiceprint feature of a payment voice command in response to the payment voice command; verifying the voiceprint feature and determining whether a user identity corresponding to the voiceprint feature matches a target user identity pre-stored in the earphone; and sending a payment command when the user identity matches the target user identity. Through the cooperation between the earphone and the paired payment device, the method not only facilitates the payment but also increase the payment security, thus improving user experience in the payment.

### CROSS-REFERENCE TO RELATED APPLICATION

This non-provisional application claims priority under 35 U.S.C. § 119(a) to Patent Application No. 202110662922.9 filed in China, P.R.C. on Jun. 15, 2021, the entire contents of which are hereby incorporated by reference.

### BACKGROUND

### Technical Field

The instant disclosure relates to payment verification, in particular, to a payment verification method, a payment verification system, a payment verification electronic device, and a payment verification storage medium.

### Related Art

With the developments of technology, the implementation of payments changes to be performed more quickly and conveniently. Payments are implemented from the traditional cash payment to the bankcard payment, and further the bankcard payment is replaced by the QR code payment and the near field communication (NFC) payment which can be implemented with the mobile phone. On the other hand, recently, biometric payments gradually become popular. The biometric payment is implemented by recognizing the biological feature of the user to perform the payment, thereby allowing the payment to become more quickly and conveniently.

### SUMMARY

Nevertheless, the biometric payment known to the inventor is prone to have security issues such as misappropriation of identity, thus affecting the user's experience for the payment procedure.

It is noted that the information disclosed in the Background Section above is intended merely to enhance the understanding of the background of the instant disclosure and may therefore comprise information that does not constitute prior art known to persons having ordinary skills in the art.

In view of this, in one embodiment, a payment verification method, a payment verification system, a payment verification electronic device, and a payment verification storage medium are provided. Through the cooperation between the earphone and the payment device paired to the earphone, payment security can be increased while facilitating the user to perform the payment.

In one embodiment, a payment verification method is provided. The method comprises monitoring a voice command received by a voice-receiving device of an earphone when a payment channel between the earphone and a payment device paired to the earphone is opened; extracting a voiceprint feature of a payment voice command in response to the payment voice command; verifying the voiceprint feature to determine whether a user identity corresponding to the voiceprint feature matches a target user identity pre-stored in the earphone; and transmitting a payment command to the payment device when the user identity matches the target user identity.

In some embodiments, the payment channel is opened when any of following criteria meets: a communication connection is established between the earphone and the payment device; or a communication connection is established between the earphone and the payment device, wherein a preset operation of the earphone is triggered; wherein the communication connection is a wired connection or a Bluetooth connection.

In some embodiments, the step of monitoring the voice command received by the voice-receiving device of the earphone comprises: performing a content recognition to the voice command when the voice-receiving device receives the voice command and determining whether a voice content of the voice command matches a target content; recognizing the voice command as the payment voice command when the voice content matches the target content.

In some embodiments, before the step of determining whether the voice content of the voice command matches the target content, the payment verification method further comprises: determining whether a voice-emitting device of the earphone already sends out a payment inquiry message or a payment verification message in a preset time duration before the voice-receiving device receives the voice command; determining the payment inquiry message or the payment verification message sent out by the voice-emitting device as the target content when the voice-emitting device already sends out the payment inquiry message or the payment verification message in the preset time duration before the voice-receiving device receives the voice command; and determining a preset payment keyword as the target content when the voice-emitting device does not already send out the payment inquiry message or the payment verification message in the preset time duration before the voice-receiving device receives the voice command.

In some embodiments, the payment verification method further comprises: monitoring a vibration signal collected by a bone conduction sensor of the earphone. Moreover, before performing the content recognition to the voice command, the payment verification method further comprises: determining whether the vibration signal collected by the bone conduction sensor is synchronized with the voice command. executing the step of performing the content recognition to the voice command when the vibration signal collected by the bone conduction sensor is synchronized with the voice command; and sending out a notification message for indicating to input the voice command again by a voice-emitting device of the earphone when the vibration signal collected by the bone conduction sensor is not synchronized with the voice command.

In some embodiments, after the step of transmitting the payment command to the payment device, the payment verification method further comprises: sending out a first vibration signal by a bone conduction sensor at one of two sides of the earphone in response to a second-time verification command for indicating an abnormal transaction, and collecting a second vibration signal by a bone conduction sensor at the other side of the earphone, where the first vibration signal is transmitted by a user to be the second vibration signal; verifying whether a vibration attenuation curve of the second vibration signal with respect to the first vibration signal matches the target user identity; performing a payment by the payment device if the vibration attenuation curve of the second vibration signal with respect to the first vibration signal matches the target user identity; and sending out a notification message for indicating that the payment is failed by a voice-emitting device of the earphone when the vibration attenuation curve of the second vibration signal with respect to the first vibration signal does not match the target user identity.

In some embodiments, after the step of transmitting the payment command to the payment device, the payment verification method further comprises: collecting a target physiological feature based on a trigger operation in response to a second time verification command for indicating an abnormal transaction, where an imitability of the target physiological feature is less than an imitability of the voiceprint feature; verifying the target physiological feature to determine whether the user identity corresponding to the target physiological feature matches the target user identity; performing a payment by the payment device when the user identity corresponding to the target physiological feature matches the target user identity; and sending out a notification message for indicating that the payment is failed by a voice-emitting device of the earphone when the user identity corresponding to the target physiological feature does not match the target user identity.

In some embodiments, the step of collecting the target physiological feature based on the trigger operation comprises: sending out the second-time verification command by the voice-emitting device of the earphone; triggering the earphone or the payment device to collect the target physiological feature based on a type of the trigger operation in a preset waiting time when the earphone receives the trigger operation; and sending out the notification message for indicating the payment is failed by the voice-emitting device when the earphone does not receive the trigger operation or when the voice-emitting device receives a verification refusal command.

In some embodiments, the target physiological feature collected by the earphone comprises a heartrate feature, the earphone stores a heartrate recognition model adapted to recognize the user identity based on the heartrate feature, and the earphone verifies the heartrate feature with the heartrate recognition model; and the target physiological feature collected by the payment device comprises a facial feature, the payment device stores a facial recognition model adapted to recognize the user identity based on the facial feature, and the payment device verifies the facial feature with the facial recognition model.

In some embodiments, after the step of performing the payment by the payment device, the payment verification method further comprises: uploading a transaction data to a Blockchain and storing the transaction data to a transaction record corresponding to the target user identity, where the transaction data comprises the payment voice command, a verification result corresponding to the second-time verification command, a transaction time, and a transaction content.

In some embodiments, after the step of transmitting the payment command to the payment device, the payment verification method further comprises: determining whether the payment device is in a Mesh network, where the Mesh network comprises a plurality of the payment devices; generating a to-be-paid record for each of the payment devices in the Mesh network when the payment device is in the Mesh network, where the to-be-paid record comprises a to-be-paid content and a to-be-paid amount; recognizing the payment device and the to-be-paid record designated by a payment-designating command in response to the payment-designating command in the Mesh network; and transmitting the to-be-paid record designated by the payment-designating command to the payment device designated by the payment-designating command to perform the payment.

In some embodiments, the payment device designated by the payment-designating command is one or more of the payment devices in the Mesh network; the to-be-paid record designated by the payment-designating command is the to-be-paid record of one or more of the payment devices in the Mesh network.

In some embodiments, the earphone stores a voiceprint recognition model adapted to recognize the user identity based on the voiceprint feature, and the earphone verifies the voiceprint feature with the voiceprint recognition model.

In some embodiments, after the step of verifying the voiceprint feature, the payment verification method further comprises: intercepting the payment command when the user identity corresponding to the voiceprint feature does not match the target user identity and sending out a notification message for indicating that a verification is failed by a voice-emitting device of the earphone; and sending out a notification message for indicating to input the voice command again by the voice-emitting device of the earphone when the voiceprint feature of the user identity corresponding to the voiceprint feature is abnormal.

In another embodiment, a payment verification system is provided. The payment verification system comprises a monitoring module, a collecting module, a verification module, and a communication module. The monitoring module is adapted to monitor a voice command received by a voice-receiving device of an earphone when a payment channel between the earphone and a payment device paired to the earphone is opened. The collecting module is adapted to extract a voiceprint feature of a payment voice command in response to the payment voice command. The verification module is adapted to verify the voiceprint feature to determine whether a user identity corresponding to the voiceprint feature matches a target user identity pre-stored in the earphone. The communication module is adapted to transmit a payment command to the payment device when the user identity corresponding to the voiceprint feature matches the target user identity.

In yet another embodiment, an electronic device is provided. The electronic device comprises a processor and a memory. The memory stores an executable command. When the executable command is executed by the processor, the payment verification method according to any of the aforementioned embodiments can be implemented.

In yet another embodiment, a non-transitory computer readable storage medium is provided. The computer readable storage medium is adapted to store a program. When the program is executed by a processor, the payment verification method according to any of the aforementioned embodiments can be implemented.

Therefore, as compared with the technology known to the inventor, one or some embodiments of the instant disclosure have advantages that at least comprise following features.

Firstly, in some embodiments, when the payment channel between the earphone and the payment device paired to the earphone is opened, the voice command received by the voice-receiving device of the earphone can be monitored, thus preventing the misappropriation of identity for payment due to loss of the payment device, and thus ensuring the earphone wearer to keep track of the transaction process to enhance the transaction security.

Moreover, in some embodiments, through verifying the voiceprint feature of the payment voice command, the payment command is transmitted to the payment device after the verification is passed, so that the user can control the payment through the voice, thus increasing the convenience for the payment, especially, but not limited to, the mobile payment when the user is riding or driving.

Furthermore, in some embodiments, the target user identity corresponds to the earphone owner of the earphone. Therefore, when the earphone owner wears the earphone and sends out the voice command, the security verification is passed, thereby greatly increasing the payment security as well as facilitating the payment through the cooperation between the earphone and the payment device paired to the earphone.

It should be noted that, the above general description and the subsequent detailed descriptions are merely illustrative and explanatory and do not limit the invention.

### BRIEF DESCRIPTION OF THE DRAWINGS

The disclosure will become more fully understood from the detailed description given herein below for illustration only, and thus not limitative of the disclosure, wherein:

FIG. 1 illustrates a schematic view showing a connection between an earphone and a payment device paired to the earphone according to an exemplary embodiment of the instant disclosure.

FIG. 2 illustrates a flowchart of a payment verification method according to an exemplary embodiment of the instant disclosure.

FIG. 3 illustrates a flowchart showing a scenario in which the identity verification is implemented by voiceprint recognition according to an exemplary embodiment of the instant disclosure.

FIG. 4 illustrates a flowchart of a payment verification method according to an exemplary embodiment of the instant disclosure.

FIG. 5 illustrates a flowchart showing a scenario in which the identity verification is implemented by heartrate recognition according to an exemplary embodiment of the instant disclosure.

FIG. 6 illustrates a flowchart showing a payment verification method according another exemplary embodiment of the instant disclosure.

FIG. 7 illustrates a schematic view showing modules of a payment verification system according to an exemplary embodiment of the instant disclosure.

FIG. 8 illustrates a schematic view showing an architecture of an electronic device according to one or some embodiments of the instant disclosure.

FIG. 9 illustrates a schematic perspective view of a computer readable storage medium according to one or some embodiments of the instant disclosure.

### DETAILED DESCRIPTION

The exemplary embodiments will now be described more fully with reference to the accompanying drawings. However, the example embodiments can be implemented in a variety of forms and should not be construed as being limited to the embodiments described herein. Rather, these embodiments make the instant disclosure comprehensive and complete, so that the ideas of the example embodiments can be provided to persons having ordinary skills in the art.

The accompanying drawings are merely schematic illustrations of the instant disclosure and are not necessarily drawn to scale. Parts with identical symbols in the drawings indicate identical or similar parts, and thus duplicate descriptions of them will be omitted. Some of the block diagrams shown in the accompanying drawings are functional entities and do not necessarily have to correspond to physically or logically separate entities. These functional entities may be implemented in software form, or in one or more hardware modules or integrated circuits, or in different networks and/or processor devices and/or microcontroller devices.

Moreover, the processes shown in the accompanied drawings are illustrative only and do not have to comprise all the steps. For example, some steps may be broken down, some steps may be combined or partially combined, and the actual order of execution of the steps may change depending on the actual situation. The use of “first”, “second”, and similar terms in the descriptions does not indicate any order, number, or importance, but rather for distinguishing between the different components. It should be noted that, the embodiments of the instant disclosure may be combined with each other and the features in the different embodiments may be combined with each other, if there is no contradiction in the combined embodiments.

According one or some embodiments of the instant disclosure, each of the steps in the payment verification method, unless the executing subject is specified, can be implemented by the earphone. Therefore, the implementation of the security verification can be ensured when the payment device receives the payment command. A processing module may be provided in the earphone to implement the payment verification method according to one or some embodiments of the instant disclosure.

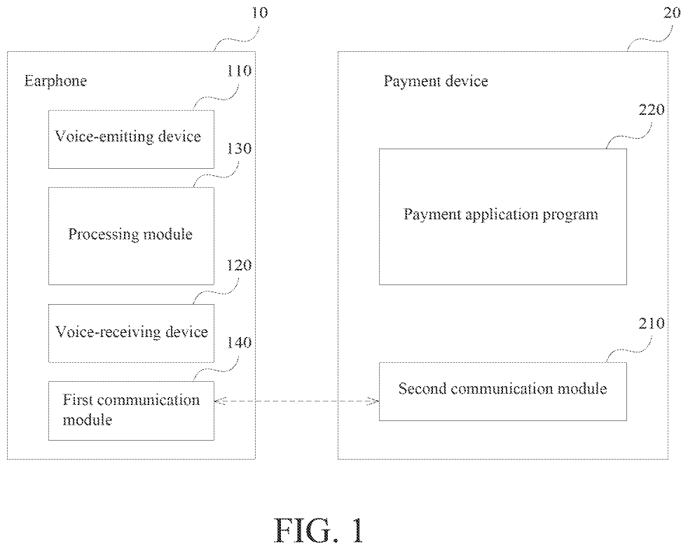

FIG. 1 illustrates a schematic view showing a connection between an earphone and a payment device paired to the earphone according to an exemplary embodiment of the instant disclosure. As shown in FIG. 1, the earphone 10 comprises a voice-emitting device 110, a voice-receiving device 120, a processing module 130, and a first communication module 140. The voice-emitting device 110 may be a speaker. The voice-receiving device 120 may be a microphone. The first communication module 140 may be a Bluetooth communication module. The processing module 130 is adapted to implement each of the steps of the payment verification method according to one or some embodiments of the instant disclosure, and the implementations will be described in the following paragraphs. The paired payment device 20 is a smart device (e.g., a smart phone or a smart watch) which has a payment function and is already paired to the earphone 10. The payment device 20 comprises a second communication module 210 and a payment application 220. The second communication module 210 is adapted to communicate with the first communication module 140 of the earphone 10. The payment application 220 is adapted to perform financial payment. The payment device 20 further comprises service application programs for providing different kinds of services. The service application program may be a music APP (application) for listening to music, a video APP for watching videos, a shopping APP for online shopping, etc. The service application programs are not illustrated in the figures.

As to an unpaired payment device, the owner of the earphone has to perform a pairing operation for the earphone and the unpaired payment device. During the pairing process, the earphone sends out verification commands several times to verify that the operation is performed by the owner of the earphone, so that the security for the pairing process can be ensured.

In some embodiments, each of the steps in the payment verification method, unless the executing subject is specified, can be implemented by a cloud server (or other devices) connected to the earphone.

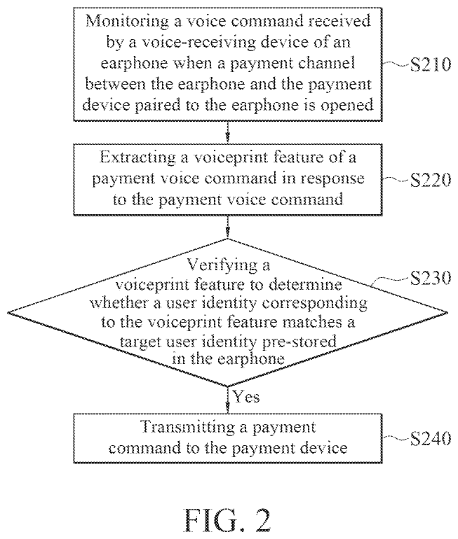

FIG. 2 illustrates a flowchart of a payment verification method according to an exemplary embodiment of the instant disclosure. As shown in FIG. 2, the payment verification method comprises steps S210-S240. The step S210: Monitoring a voice command received by a voice-receiving device of an earphone when a payment channel between the earphone and the payment device paired to the earphone is opened. The Step S220: Extracting a voiceprint feature of a payment voice command in response to the payment voice command. The step S230: Verifying a voiceprint feature to determine whether a user identity corresponding to the voiceprint feature matches a target user identity pre-stored in the earphone. The step S240: Transmitting a payment command to the payment device if yes (i.e. transmitting a payment command to the payment device if the user identity matches the target user identity).

When a communication connection is established between the earphone and the paired payment device, the payment channel is opened. Hence, it can be ensured that the payment channel is opened when the earphone and the paired payment device are within a safety distance from each other, thus preventing the misappropriation of identity for payment due to loss of the payment device. The communication connection may be a wired connection or a Bluetooth connection. Concerning that the wireless Bluetooth earphones are mainstream earphone products, the Bluetooth connection is taken as an illustrative example for the examples below, but embodiments are not limited thereto.

In a scenario, the user A wears the wireless Bluetooth earphone during driving, and the Bluetooth function of the smart phone of the user A is enabled. Hence, the smart phone automatically searches the wireless Bluetooth earphone to establish the Bluetooth connection between the smart phone and the earphone, and the payment channel is opened accordingly.

The payment channel between the earphone and the payment device may be opened when a communication connection is established between the earphone and the payment device and a preset operation of the earphone is triggered. Hence, the payment security can be further enhanced. Therefore, the payment channel can be opened with the operation of the owner of the earphone, and even a third person steals both the earphone and the payment device, he or she cannot perform the payment fraudulently. Moreover, the resources for monitoring the earphone can be reduced, thereby further reducing power consumption.

The preset operation may be performed in a press manner or a touch manner. For example, the preset operation may be continuously tapping the left earphone two times, pressing the left earphone for three seconds, etc. The preset operation may be set by the owner of the earphone in advance.

The voice command received by the voice-receiving device of the earphone is usually the voice of the wearer of the earphone, and the environmental noises are not recorded to ensure that the wearer of the earphone can keep track of the transaction process, thus increasing the transaction security. The monitoring process may be implemented by the processing module of the earphone. After the payment channel is opened, the processing module of the earphone monitors the voice command received by the voice-receiving device of the earphone in a real-time manner. If the processing module determines that the voice command is the payment voice command, the payment verification operation is executed. If the processing module determines that the voice command is other voice commands such as command for playing songs or changing songs, then the corresponding operation is executed accordingly.

In one embodiment, the step of monitoring the voice command received by the voice-receiving device of the earphone comprise performing a content recognition to the voice command when the voice-receiving device receives the voice command and determine whether a voice content of the voice command matches a target content. If yes, recognizing the voice command as the payment voice command (i.e. recognizing the voice command as the payment voice command if the voice content matches the target content).

It is understood that the recognition of the voice content may be implemented with known technologies, and not iterated here.

The target content may be a payment keyword, or may be a payment inquiry message or a payment verification message. Specifically, in this embodiment, before the step of determining whether the voice content of the voice command matches the target content, the payment verification method further comprises determining whether a voice-emitting device of the earphone already sends out a payment inquiry message or a payment verification message in a preset time duration before the voice-receiving device receives the voice command. If yes, determining the payment inquiry message or the payment verification message sent out by the voice-emitting device as the target content (i.e. determining the payment inquiry message or the payment verification message sent out by the voice-emitting device as the target content if the voice-emitting device already sends out the payment inquiry message or the payment verification message in the preset time duration before voice-receiving device receives the voice command) If no, determining a preset payment keyword as the target content (i.e. determining a preset payment keyword as the target content if the voice-emitting device does not already send out the payment inquiry message or the payment verification message in the preset time duration before the voice-receiving device receives the voice command).

The preset time duration is a time duration preserved for the user to provide a response, and for example, the preset time duration may be five seconds. In a scenario, a user B is wearing the earphone to listen to the song provided by a music APP (application) of the payment device. When a current song “Sunny day” is playing, owing to the copyright, the user can only listen to a part of the whole song. When the trial part of the song “Sunny day” is played, the music App sends out a payment inquiry message such as: “the trial for the song ‘Sunny day’ is over, would you like to purchase the whole song?” The payment verification message is transmitted to the earphone by the payment device, sent out by the voice-emitting device of the earphone, and monitored by the processing module of the earphone. Therefore, the processing module of the earphone monitors the voice command received by the voice-receiving device to determine whether the user feedbacks a voice command matching the target content “agree to purchase” in the preset time duration.

In another scenario, the user may send out the payment voice command autonomously. For example, when a user C listens to the content provided by a radio station APP of the payment device with the earphone and wishes to purchase the album being introduced by a radio station, the user C can send out the voice command “purchase the album”. Then, after the processing module of the earphone monitors the voice command, the processing module performs the content recognition to the voice command and compares the voice command with preset payment keywords that cover all meaning for the term “payment”, so that the voice command is recognized as the payment voice command.

Furthermore, in one or some embodiments, after the payment application receives the payment command, for security reasons, the payment application may send out a payment verification message. For example, the payment verification message may be “please say the voice command ‘365849’ to ensure the payment”. Then, when the processing module of the earphone monitors the voice command matching the target content “365849” in the preset time duration, the processing module recognizes the voice command as the payment voice command. The payment verification message may be a random-generated numerical verification code. In this embodiment, owing to the randomness of the payment verification message, the payment verification message can be prevented from being plagiarized by others. Moreover, the computation requirements for recognizing the voice content can be reduced, the use of computing resources can be reduced, and the verification speed can be increased.

According to one or some embodiments, the voice-emitting device of the earphone sends out the payment inquiry message or the payment verification message, and the voice command is received by the voice-receiving device of the earphone. Hence, the payment verification method can be executed with a strong security protection. Therefore, fraudulent transmission of messages and wiretapping by others can be prevented, thereby greatly increasing the payment security.

Moreover, in one embodiment, the payment verification method not only comprises the step of monitoring the voice command received by the voice-receiving device of the earphone, but also comprises the step of monitoring a vibration signal collected by a bone conduction sensor of the earphone. Further, in this embodiment, before the step of performing the content recognition to the voice command, the payment verification method further comprises determining whether the vibration signal collected by the bone conduction sensor is synchronized with the voice command. If yes, executing the step of performing the content recognition to the voice command (i.e. executing the step of performing the content recognition to the voice command if the vibration signal collected by the bone conduction sensor is synchronized with the voice command) If no, sending out a notification message for indicating to input the voice command again by the voice-emitting device of the earphone (i.e. sending out a notification message for indicating to input the voice command again by the voice-emitting device of the earphone if the vibration signal collected by the bone conduction sensor is not synchronized with the voice command.

The bone conduction sensor of the earphone can monitor the vibration signal generated upon the wearer of the earphone is talking. With the determination of whether the vibration signal and the voice command are synchronized in time, the voice command is ensured to be sent out from the wearer of the earphone. Therefore, misrecognition for the voices uttered by others near the earphone can be prevented, thus increasing the security as well as reducing the computing resources for voice content recognition and for subsequent verification. If the bone conduction sensor does not collect the vibration signal synchronized with the voice command, in order to prevent incomplete collection caused by short talking time or improper wearing of the earphone, the user will be alerted by the voice-emitting device to input the voice command again.

When the payment voice command is monitored, the voiceprint feature of the payment voice command is extracted to perform identity verification. In one embodiment, the earphone stores a voiceprint recognition model adapted to recognize the user identity based on the voiceprint feature, and the earphone verifies the voiceprint feature with the voiceprint recognition model.

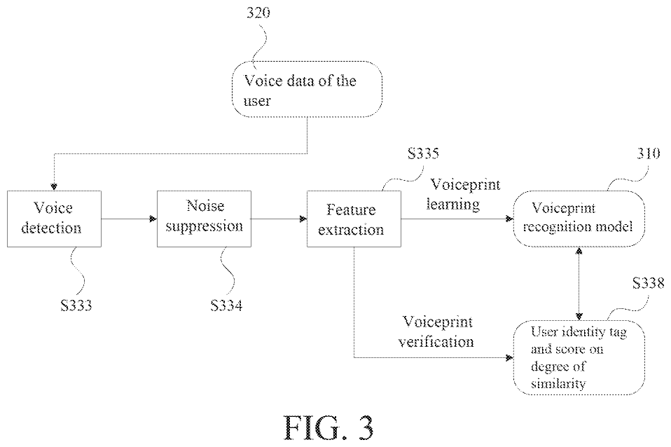

FIG. 3 illustrates a flowchart showing a scenario in which the identity verification is implemented by voice recognition according to an exemplary embodiment of the instant disclosure. As shown in FIG. 3, the voiceprint recognition model 310 is trained in advance, so that the voiceprint recognition model 310 is adapted to recognize the identity of the person who is speaking based on the voiceprint feature of the person. Moreover, the voiceprint recognition model 310 stores a target user identity tag of the user in advance, and such storing can be implemented upon the user 320 uses the earphone. Specifically, in this embodiment, upon the user 320 uses the earphone, the processing module of the earphone extracts the voiceprint feature from a voice data of the user 320, transmits the voiceprint feature to the voiceprint recognition model 310 for training, and registers the voiceprint feature of the user 320 in the voiceprint recognition model 3101. Specifically, in some embodiments, the learning process comprises step S333-S338. The Step S333: Performing voice detection to the voice data of the user by the processing module of the earphone, for example, extracting the effective voice data from the voice data. The step S334: Performing noise suppression to filter unrelated noises in the effective voice data. The step S335: Performing feature extraction to extract the voiceprint feature in the effective voice data and transmitting the voiceprint feature to the voiceprint recognition model 310 for voiceprint learning. The step S338: The voiceprint feature of the payment voice command is transmitted to the voiceprint recognition model 310 for voiceprint recognition, and a user identity tag and a score on degree of similarity outputted by the voiceprint recognition model 310 can be obtained. In the practical verification process, for the received payment voice command, the steps S333-S335 are implemented to perform the voice detection, the noise suppression, and the feature extraction, so that the voiceprint feature of the payment voice command can be obtained. Then, the step S338 is executed. If the user identity tag matches the target user identity tag of the user 320 and the degree of similarity is greater than a threshold value, then it is determined that the user identity corresponding to the voiceprint feature matches the target user identity pre-stored in the earphone; otherwise, it is determined that the user identity corresponding to the voiceprint feature does not match the target user identity pre-stored in the earphone.

Specifically, the voiceprint recognition model 310 may adopt existing algorithms that can accurately recognize whether the person who is talking or speaking is the pre-stored target person whose user identity is pre-stored, and the recognition accuracy for the algorithms is more than 99%, detail descriptions for the algorithms are not provided.

Specifically, in one embodiment, after the step of verifying the voiceprint feature, the payment verification method further comprises: intercepting the payment command if the user identity corresponding to the voiceprint feature does not match the target user identity and sending out a notification message for indicating that a verification is failed by the voice-emitting device of the earphone; and sending out a notification message for indicating to input the voice command again by the voice-emitting device of the earphone if the voiceprint feature or the user identity corresponding to the voiceprint feature is abnormal.

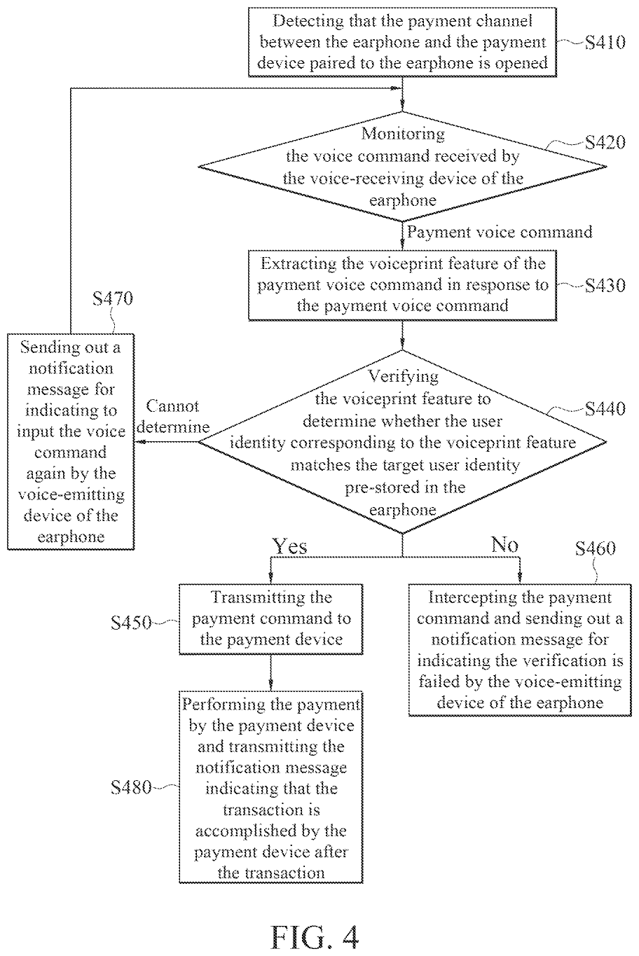

FIG. 4 illustrates a flowchart of a payment verification method according to an exemplary embodiment of the instant disclosure. As shown in FIG. 4, in one embodiment, a relatively complete flowchart of the payment verification method comprises: the step S410, detecting that the payment channel between the earphone and the payment device paired to the earphone is opened; the step S420, monitoring the voice command received by the voice-receiving device of the earphone; the step S430, extracting the voiceprint feature of the payment voice command in response to the payment voice command; the step S440, verifying the voiceprint feature to determine whether the user identity corresponding to the voiceprint feature matches the target user identity pre-stored in the earphone; if yes, executing the step S450, transmitting the payment command to the payment device (transmitting the payment command to the payment device if the user identity corresponding to the voiceprint feature matches the target user identity pre-stored in the earphone); if no, executing the step S460, intercepting the payment command and sending out a notification message for indicating the verification is failed by the voice-emitting device of the earphone (intercepting the payment command and sending out a notification message for indicating the verification is failed by the voice-emitting device of the earphone if the user identity corresponding to the voiceprint feature does not match the target user identity pre-stored in the earphone); if it is the condition that whether the user identity corresponding to the voiceprint feature matches the target user identity cannot be determined, executing the step S470, sending out a notification message for indicating to input the voice command again by the voice-emitting device of the earphone, and returning back to the step S420 to monitor whether the payment voice command sent out the user is received.

Specifically, in this embodiment, the condition that whether the user identity corresponding to the voiceprint feature matches the target user identity cannot be determined may be: the voiceprint feature is abnormal (e.g., the voice is too small, the speaking time is too short, or the environmental noise is too loud, such that the effective voiceprint feature cannot be extracted), or the user identity corresponding to the voiceprint feature is abnormal (e.g., the voiceprint recognition model does not output effective identity recognition result). The payment command the earphone transmits to the payment device comprises messages regarding the pass of the identity verification and messages regarding the current payment transaction. After the earphone transmits the payment command to the payment device, the payment verification method further comprises the step S480, performing the payment by the payment device and transmitting the notification message indicating that the transaction is accomplished by the payment device after the transaction, so that the user can keep track of the transaction progress and understand the transaction result.

Hence, with the payment verification method according to one or some embodiments of the instant disclosure, the user can operate the payment procedure with voices. Especially, according to one or some embodiments, in the scenario that the user is going to purchase something upon the user is driving or riding, the user does not need to operate the payment device by hand which will cause potential safety issues, the user also does not need to stop the driving or riding for the transaction which will affect the original driving or riding plan, and further the user also does not need to postpone the transaction which may cause the user forget the route for the transaction. Instead, the user can just say the payment voice command to proceed the verification, and the payment for the transaction can be accomplished after the verification is passed, thereby greatly facilitating the mobile payment. Moreover, in the verification process, the target user identity corresponds to the owner of the earphone. Therefore, when the earphone owner wears the earphone and sends out the voice command, the security verification is passed, thereby greatly increasing the payment security as well as facilitating the payment.

In one embodiment, the payment device receives the payment command, and the payment device performs the payment through a corresponding payment application. In the payment, the payment application or the financial party (e.g., the bank), will perform a risk predetermination procedure for the current transaction. If a risk condition such as the transaction amount of the current transaction is greater than a certain threshold value. If the time interval between the current transaction and the previous transaction is less than a certain time threshold value occurs, the current transaction can be determined to be abnormal, and a second-time verification is send out by the earphone.

In one or some embodiments, the payment verification method further comprises: sending out a first vibration signal by a bone conduction sensor at one of two sides of the earphone in response to the second-time verification command for indicating an abnormal transaction, and collecting a second vibration signal by a bone conduction sensor at the other side of the earphone; where the first vibration signal is transmitted by the user to be the second vibration signal; verifying whether a vibration attenuation curve of the second vibration signal with respect to the first vibration signal matches the target user identity. If yes, performing the payment by the payment device (performing the payment by the payment device. if the vibration attenuation curve of the second vibration signal with respect to the first vibration signal matches the target user identity); and if no, sending out a notification message for indicating that the payment is failed by the voice-emitting device of the earphone (sending out a notification message for indicating that the payment is failed by the voice-emitting device of the earphone if the vibration attenuation curve of the second vibration signal with respect to the first vibration signal does not match the target user identity).

Specifically, in this embodiment, when the earphone receives the second-time verification command transmitted by the payment device, the earphone sends out the first vibration signal by the bone conduction sensor at one of two sides of the earphone (for example, by the left-sided bone conduction sensor). The voice content corresponding to the first vibration signal may be “The payment verification is in progress. Please wait.” After the first vibration signal is transmitted through the skin, the soft tissues, the skeletons, and other media of the user, a certain signal decay occurs to the first vibration signal. The second vibration signal is collected by the bone conduction sensor at the other side of the earphone (for example, by the right-sided bone conduction sensor), where the first vibration signal is transmitted by the user to be the second vibration signal. Hence, the processing module of the earphone can compares the second vibration signal with the first vibration signal to obtain a vibration attenuation curve of the second vibration signal with respect to the first vibration signal. The vibration attenuation curve may be calculated by known methods, and embodiments are not limited thereto.

A vibration attenuation function corresponding to the target user identity is pre-stored in the processing module of the earphone. The vibration attenuation function may adopt existing machine models, such that the vibration attenuation function can be learned during the daily use of the earphone by the user, and details descriptions for obtaining the vibration attenuation function are not provided. It is determined whether the vibration attenuation curve matches the identity of the target user by comparing whether the degree of matching between the vibration attenuation curve and the vibration attenuation function is greater than a set threshold.

Therefore, in one or some embodiments of the instant disclosure, the user identity can be verified through bone conduction. Hence, the user can obtain the verification result without performing further operations, thereby facilitating the mobile payment when the user is moving.

In one embodiment, by combining the voice command with other physiological features, dual verification may be applied to a current transaction which is recognized as abnormal.

Specifically, in one or some embodiments, the payment verification method further comprise: collecting a target physiological feature based on a trigger operation in response to a second-time verification command for indicating an abnormal transaction; where an imitability of the target physiological feature is less than an imitability of the voiceprint feature; verifying the target physiological feature to determine whether the user identity corresponding to the target physiological feature matches the target user identity; if yes, performing a payment by the payment device (performing a payment by the payment device if the user identity corresponding to the target physiological feature matches the target user identity); if no, sending out a notification message for indicating that the payment is failed by the voice-emitting device of the earphone (sending out a notification message for indicating that the payment is failed by a voice-emitting device of the earphone if the user identity corresponding to the target physiological feature does not match the target user identity).

The voiceprint feature belongs to a behavioral biometric feature. It is understood that, in some embodiments, although the payment verification method may be implemented through the voice command received by the earphone and the messages for verifying the payment, possibility that the voiceprint feature is imitated still exists. Accordingly, in this embodiment, the accuracy for the verification can be further increased through collecting the physiological biometric feature whose imitability is less than the imitability of the voiceprint feature. The target physiological feature may be a heartrate feature, a facial feature, a pupil feature, or the like, and can be collected by the payment device or the earphone.

Specifically, in this embodiment, the step of collecting the target physiological feature based on the trigger operation comprises: sending out a second-time verification command by the voice-emitting device of the earphone; triggering the earphone or the payment device to collect the target physiological feature based on a type of the trigger operation in a preset waiting time if the earphone receives the trigger operation; sending out the notification message for indicating that the payment is failed by the voice-emitting device if the earphone does not receive the trigger operation or if the voice-emitting device receive a verification refusal command.

In this embodiment, the trigger operation is set by the user in advance, and the trigger operation is adapted to trigger the sensor(s) of the earphone or the payment device to collect the target physiological feature. The trigger operation for triggering the sensor(s) of the earphone to collect the target physiological feature is regarded as a first type trigger operation, for example, may be tapping the left earphone several times. The trigger operation for triggering the payment device to collect the target physiological feature is regarded as a second type trigger operation, for example, may be tapping the right earphone several times. When the earphone receives the trigger operation in the preset waiting time, the sensor(s) of the earphone or the payment device is triggered based on the type of the trigger operation to perform the collection procedure. If the earphone does not receive the trigger operation or if the voice-receiving device of the earphone receives the verification refusal command (e.g., the user sends out a voice command “No payment”), then the payment verification is stopped and the notification message indicating that the payment is failed is sent out by the voice-emitting device.

The target physiological feature collected by the earphone comprises the heartrate feature. In this embodiment, the earphone comprise a heartrate sensor, the earphone stores a heartrate recognition model adapted to recognize the user identity based on the heartrate feature, and the earphone verifies the heartrate feature with the heartrate recognition model.

The principle for recognizing the user identity based on the heartrate feature is described as below. Owing to the physiological difference among different human bodies, such as the location and the size of the heart, the muscles of the heart, the activation order of the heart, the conductivity of the heart, different human bodies can be distinguished through identifying the heterogeneity of the electrocardiography (ECG) forms. The heartrate sensor is adapted to collect the heartrate data to generate the ECG signals, and then the processing module of the earphone can analyze over than 192 parameters (such as, peak amplitude, waveform time interval, change of length and angle of the heart depolarization vector and the heart repolarization vector, so that the user identity can be recognized.

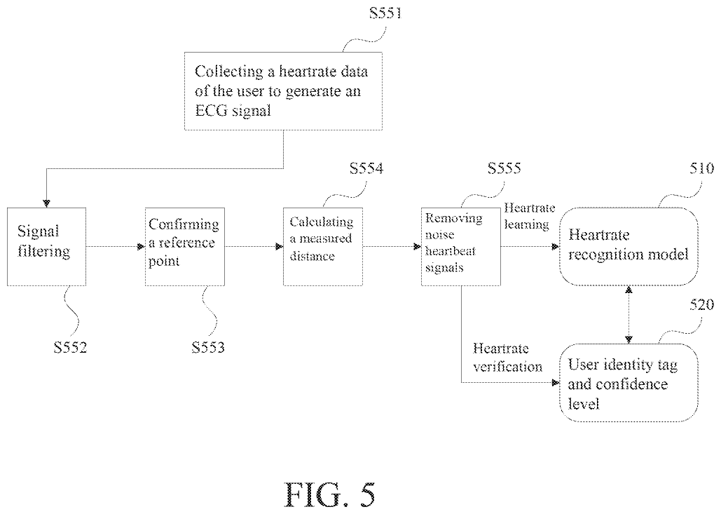

FIG. 5 illustrates a flowchart showing a scenario in which the identity verification is implemented by heartrate recognition according to an exemplary embodiment of the instant disclosure. As shown in FIG. 5, the heartrate recognition model 510 is trained in advance, and the heart recognition model 510 is adapted to recognize the user identity based on the heartrate feature. Upon the user uses the earphone, the heartrate recognition model 510 firstly learns the heartrate feature of the user and pre-stores the target user identity tag of the user. Specifically, in one or some embodiments, the learning process comprises: the step S551, collecting a heartrate data of the user by the heartrate sensor of the earphone to generate an ECG signal; the step S552, performing signal filtering to the ECG signal; the step S553, confirming a reference point in the ECG signal; the step S554, calculating a measured distance, namely, in this embodiment, the distance between the peak and the valley of the ECG signal; the step S555, removing noise heartbeat signals from the heartrate data and transmitting the obtained heartrate feature into the heartrate recognition model 510 for learning, such that the measured distance of the user which is at a standard range can be registered to the heartrate recognition model 510. In the practical verification process, for the heartrate data received from the user, the steps S551-S555 are implemented to perform data processing to obtain the current heartrate feature, and then the heartrate feature is transmitted to the heartrate recognition model 510 for heartrate recognition. Last, the user identity tag and the confidence level of the user identity tag outputted by the heartrate recognition model 510 can be obtained. If the user identity tag matches the target user identity tag and the confidence level exceeds a threshold value, then it is determined that the user identity corresponding to the target physiological feature matches the target user identity; otherwise, it is determined that the user identity corresponding to the target physiological feature does not match the target user identity.

Specifically, the heartrate recognition model 510 may adopt existing algorithms (such as support vector machine (SVM) classifier). After training, the user identity can be recognized rapidly with a number of 1.02 heartrate data within 0.6 to 1.2 seconds. Detail descriptions for the algorithms are not provided.

Moreover, by using the earphone comprising the heartrate sensor, during the daily use of the earphone by the user, the earphone can perform health monitoring to the user, and the earphone can send out the notification in time when the earphone monitors that the heartrate of the user is abnormal.

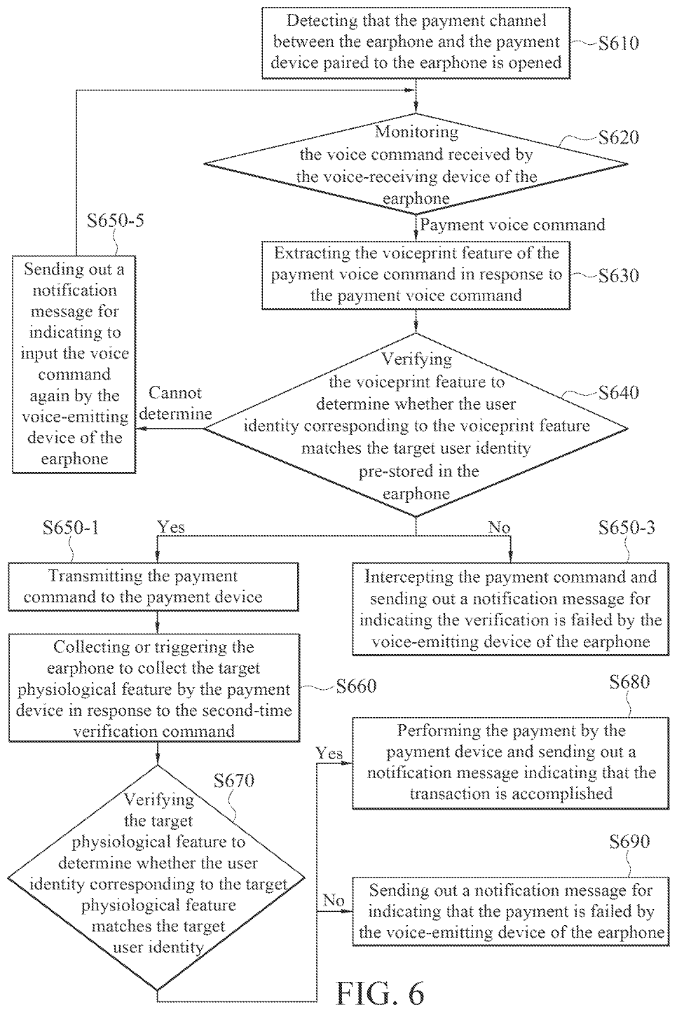

FIG. 6 illustrates a flowchart showing a payment verification method according another exemplary embodiment of the instant disclosure. In this embodiment, the payment verification method comprises both the voiceprint verification and the heartrate verification. As shown in FIG. 6, the dual verification comprises: the step S610, detecting that the payment channel between the earphone and the payment device paired to the earphone is opened; the step S620, monitoring the voice command received by the voice-receiving device of the earphone; the step S630, extracting the voiceprint feature of the payment voice command in response to the payment voice command; the step S640, verifying the voiceprint feature to determine whether the user identity corresponding to the voiceprint feature matches the target user identity pre-stored in the earphone; if yes, executing the step S650-1, transmitting the payment command to the payment device (transmitting the payment command to the payment device if the user identity corresponding to the voiceprint feature matches the target user identity pre-stored in the earphone); if no, executing the step S650-3, intercepting the payment command and sending out a notification message for indicating that the payment is failed by the voice-emitting device of the earphone (intercepting the payment command and sending out a notification message for indicating that the payment is failed by the voice-emitting device of the earphone if the user identity corresponding to the voiceprint feature does not match the target user identity pre-stored in the earphone); if it is the condition that whether the user identity corresponding to the voiceprint feature matches the target user identity cannot be determined, executing the step S650-5, sending out a notification message for indicating to input the voice command again by the voice-emitting device, and returning back to the step S620 to monitor whether the payment voice command sent out by the user is received. After the step of transmitting the payment command to the payment device, the payment verification method further comprises: the step S660, collecting or triggering the earphone to collect the target physiological feature by the payment device in response to the second-time verification command indicating an abnormal transaction; the step S670, verifying the target physiological feature to determine whether the user identity corresponding to the target physiological feature matches the target user identity; if yes, executing the step S680, performing the payment by the payment device and sending out a notification message indicating that the transaction is accomplished (performing the payment by the payment device and sending out a notification message indicating that the transaction is accomplished if the user identity corresponding to the target physiological feature matches the target user identity); if no, executing the step S690, sending out a notification message for indicating that the payment is failed by the voice-emitting device of the earphone (sending out a notification message for indicating that the payment is failed by the voice-emitting device of the earphone if the user identity corresponding to the target physiological feature does not match the target user identity). Accordingly, the user can keep track of the transaction progress in time and understand the transaction result.

According to one or some embodiments of the instant disclosure, through implementing the payment verification method with dual verification having the voiceprint feature and the heartrate feature, the accuracy for identity verification can be greatly increased, thus increasing the payment security.

The target physiological feature collected by the payment device comprises the facial feature. In this embodiment, the payment device stores a facial recognition model adapted to recognize the user identity based on the facial feature, and the payment device verifies the facial feature with the facial recognition model. The step of collecting the facial feature by the payment device can be implemented by the selfie function of the payment device. When the payment device is triggered, the front camera is enabled, and the user is notified to take the selfie with some requirements. For example, the user may have to take the selfie with his/her eyes opened to prevent a third person to unlock the payment device with a photo of the user. After the selfie is taken, the payment device extracts the facial feature of the user from the selfie photo and transmits the facial feature into the facial recognition model to perform the identity verification. It is understood that, recognizing the user identity based on the facial feature is a common function for the payment device, thus the principle for the identity recognition is not described here.

After the dual verification is passed, the payment is performed by the payment device. The payment application of the payment device may directly perform the payment to a payment platform corresponding to the payment voice command, or the payment application may just provide a payment QR code of the payment application. Specifically, in one or some embodiments, if the payment voice command corresponds to a certain payment platform, the payment may be directly performed to the payment platform after the dual verification is passed. In one or some embodiments, in an offline payment scenario, for the sake of convenience, the user may obtain the payment QR code directly by the payment voice command to perform the payment may. For example, when the payment channel between the earphone and the payment device is opened, the user says the payment voice command comprising any payment keyword such as “pay the bill”, “payment”, or “check”. In this condition, the payment voice command does not correspond to any payment platform. Then, after the voiceprint verification is passed, the second-timer verification command is generated for the sake of safety to execute the dual verification. After the dual verification is passed, the payment QR code of the payment application is displayed on the payment device, so that the user can perform the payment offline without manually opening the payment application of the payment device, thereby increasing the convenience of the payment.

Furthermore, in one embodiment, after the step of performing the payment by the payment device, the payment verification method further comprises: uploading a transaction data to a Blockchain and storing the transaction data to a transaction record corresponding to the target user identity, where the transaction data comprises the payment voice command, a verification result corresponding to the second-time verification command, a transaction time, and a transaction content. Therefore, the transaction process can be tracked.

According to one or some embodiments of the instant disclosure, in the case that the earphone and the payment device are connected to each other through the Bluetooth connection, upon the commands are transmitted between the earphone and the payment, a proper profile (in this embodiment, the Bluetooth communication protocol) are selected automatically according to the current Bluetooth configuration. The profile may comprise basic imaging profile (BIP), audio video remote control profile (AVRCP), etc. Moreover, it is understood that, how to select the profile and how to perform communication under different Bluetooth communication protocols are known and not described here. Moreover, in order to prevent conflicts during switching the profile, the switching between different trigger scenarios can be implemented by configuring the triggering operations for different trigger scenarios with different triggering types. For example, the first type trigger operation and the second type trigger operation may be applied to trigger the earphone and the payment device to collect data, and not repeated here.

In one embodiment, the payment verification method may be combined with a Mesh network (wireless mesh network) to solve payment issues such as when many people tend to apportion the payment.

In some embodiments, after the step of transmitting the payment command to the payment device, the payment verification method further comprises: determining whether the payment device is in a Mesh network, where the Mesh network comprises a plurality of the payment devices. if yes, generating a to-be-paid record for each of the payment devices in the Mesh network (generating a to-be-paid record for each of the payment devices in the Mesh network if the payment device is in the Mesh network), where the to-be-paid record comprises a to-be-paid content and a to-be-paid amount; recognizing the payment device and the to-be-paid record designated by a payment-designating command in response to the payment-designating command in the Mesh network and transmitting the to-be-paid record designated by the payment-designating command to the payment device designated by the payment-designating command to perform the payment. The payment device designated by the payment-designating command is one or more of the payment devices in the Mesh network, and the to-be-paid record designated by the payment-designating command is the to-be-paid record of one or more of the payment devices in the Mesh network.

When many people order food in a restaurant or in an office, it is easy to forget who ordered the meal and how much to pay for the meal. Therefore, according to one or some embodiments of the instant disclosure, for the multi-people payment verification application, for example, in the scenario that many users order food in the restaurant, the users establish a Mesh network with their payment devices, then the users have respective orders. The voice commands during the ordering process, such as “I would like to have a xxx dish” or “I would like to order a xxx dish” are recognized as the payment voice commands After the voiceprint verification is passed, each of the payment devices records a to-be-paid content comprising the order content and the price for the order. After the ordering process, the method allows the bill to be paid by each of the users individually, to be shared by each of the users, or to be paid by only one user.

For example, if one of the users says a voice command “my treat”, then the earphone of the user receives the voice command, recognizes the voice command as the payment-designating command, and transmits the payment-designating command to the corresponding payment device. After the payment device analyzes the payment-designating command, the payment device recognizes that the payment device designated by the payment-designating command is the payment device itself, and the to-be-paid record designated by the payment-designating command is all the to-be-paid records in the Mesh network. Hence, the payment device generates a payment confirmation message integrating all the to-be-paid records in the Mesh network. After the user confirms the message, the payment can be performed, thereby achieving multi-people payment verification conveniently.

According to one or some embodiments of the instant disclosure, a payment verification method is further provided. The payment verification system may be configured in the earphone to implement the payment verification method according to any of the aforementioned embodiments. It is understood that, the features and the principles described in any of the aforementioned embodiments can be applied to one or some embodiments of the payment verification system. In the embodiments of the payment verification system, the features and the principles regarding the payment verification are not described again.

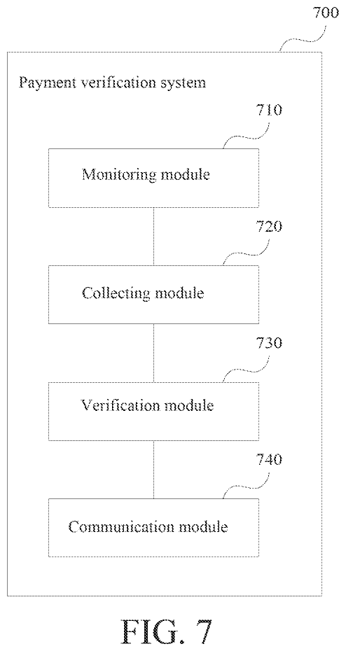

FIG. 7 illustrates a schematic view showing some modules of a payment verification system according to an exemplary embodiment of the instant disclosure. As shown in FIG. 7, the payment verification system comprises a monitoring module 710, a collecting module 720, a verification module 730, and a communication module 740. The monitoring module 710 is adapted to monitor the voice command received by the voice-receiving device of the earphone when the payment channel between the earphone and the payment device paired to the earphone is opened. The collecting module 720 is adapted to extract the voiceprint feature of the payment voice command in response to the payment voice command. The verification module 730 is adapted to verify the voiceprint feature to determine whether the user identity corresponding to the voiceprint feature matches the target user identity pre-stored in the earphone. The communication module 740 is adapted to transmit the payment command to the payment device if the user identity corresponding to the voiceprint feature matches the target user identity.

Furthermore, the payment verification system may comprise modules capable of implementing the payment verification method according to one or some embodiments, the principles of the modules can be referenced to the descriptions of the embodiments, and are not described here.

As mentioned above, in the payment verification system according to one or some embodiments of the instant disclosure, through the cooperation between the earphone and the payment device paired to the earphone, the user can control the payment through the voice. Therefore, the convenience for the payment is increased. Especially, but not limited to, the convenience for the mobile payment is increased when the user is riding or driving. Moreover, according to one or some embodiments, it is ensured that the wearer of the earphone can keep track of the transaction process. Therefore, in this embodiment, only when the earphone owner wears the earphone and sends out the voice command, the security verification is passed, thus preventing the misappropriation of identity for payment due to loss of the payment device and greatly increasing the payment security.

According to one or some embodiments of the instant disclosure, an electronic device is provided. The electronic device comprises a processor and a memory. The memory stores an executable command. When the executable command is executed by the processor, the payment verification method according to any of the aforementioned embodiments can be implemented.

As mentioned above, in the electronic device according to one or some embodiments of the instant disclosure, through the cooperation between the earphone and the payment device paired to the earphone, the user can control the payment through the voice. Therefore, the convenience for the payment is increased. Especially, but not limited to, the convenience for the mobile payment is increased when the user is riding or driving. Moreover, according to one or some embodiments, it is ensured that the wearer of the earphone can keep track of the transaction process. Therefore, in this embodiment, only when the earphone owner wears the earphone and sends out the voice command, the security verification is passed, thus preventing the misappropriation of identity for payment due to loss of the payment device and greatly increasing the payment security.

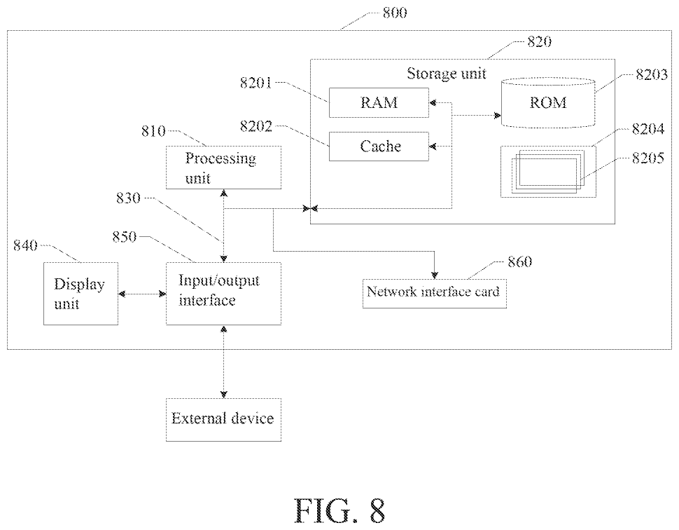

FIG. 8 illustrates a schematic view showing an architecture of an electronic device according to one or some embodiments of the instant disclosure. It should be noted that, in FIG. 8, the modules are illustrated for illustrative purposes. These modules may be visual software modules or physical hardware modules. Furthermore, it should be noted that, combinations or separations of the modules or addition of other modules are within the scope of the invention.

As shown in FIG. 8, the electronic device is presented as a general-computing device. The electronic device may comprise, but not limited to, at least one processing unit 810, at least one storage unit 820, a bus bar 830 connected between different components (comprising the storage unit 820 and the processing unit 810), and a display 840.

The storage unit 840 stores codes. The codes can be executed by the processing unit 810, so that the processing unit 810 execute the steps of the payment verification method according to any of the aforementioned embodiments.

The storage unit 820 may comprise a volatile readable medium, such as a random access memory (RAM) 8201 and/or a cache memory 8202, and may further comprise a read-only memory (ROM) 8203.

The storage unit 820 may further comprise a program/tool 8204 having one or more program modules 8205. The program module 8205 may comprise but not limited to, an operation system, one or more application programs, other program modules, and program data. Each of some combinations of the embodiments may comprise the implementation of the network environments.

The bus bar 830 may be one or more of the bus bar structures. The bus bar structure may comprise a storage unit bus bar. Moreover, the bus bar structure may comprise a storage unit controller, a peripheral bus bar, an accelerated graphics port, and a processing unit. Furthermore, the bus bar structure may comprise a local bus bar utilizing any bus bar structure in various bus bar structures.

The electronic device 800 may communicate with one or more external devices. The external device may be one or more of a keyboard, a pointing device, a Bluetooth device, etc. The eternal devices allow the user to have mutual communication with the electronic device 800. The electronic device 800 may communicate with one or more computing devices. The computer device (computing device) may be a router or a modem. The communication may be implemented through the input/output interface 850. Moreover, the electronic device 800 may communicate with one or more networks (such as local area network (LAN), wide area network (WAN), and/or public network (such as Internet) through a network interface card 860. The network interface card 860 may communicate with other modules of the electronic device 800 through the bus bar 830. It should be noted that, the electronic device 800 may be combined with other hardware and/or software modules, and the modules may comprise but not limited to, microcode, device drivers, redundant processing units, external disk drive arrays, RAID systems, tape drives, data backup storage platforms, etc.

According to one or some embodiments of the instant disclosure, a non-transitory computer readable storage medium is provided. The computer readable storage medium is adapted to store a program. When the program is executed by a processor, the payment verification method according to any of the aforementioned embodiments can be implemented. In some possible implementations of one or some embodiments of the instant disclosure, a program product comprising codes can be provided. When the program product is run on a terminal device, the codes are adapted to allow the terminal device to execute the payment verification method according to one or some embodiments of the instant disclosure.

As mentioned above, in the computer readable storage medium according to one or some embodiments of the instant disclosure, through the cooperation between the earphone and the payment device paired to the earphone, the user can control the payment through the voice, thus increasing the convenience for the payment but not limited to the mobile payment when the user is riding or driving. Moreover, according to one or some embodiments, it is ensured that the wearer of the earphone can keep track of the transaction process. Therefore, in this embodiment, only when the earphone owner wears the earphone and sends out the voice command, the security verification is passed, thus preventing the misappropriation of identity for payment due to loss of the payment device and greatly increasing the payment security.

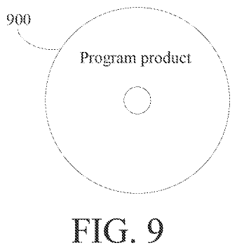

FIG. 9 illustrates a schematic perspective view of a computer readable storage medium according to one or some embodiments of the instant disclosure. As shown in FIG. 9, a program product 900 adapted to implement the aforementioned payment verification method according to one or some embodiments is described. The program product 900 may be a compact hard disk read-only memory (CD-ROM) and comprise codes, and the program product can be run on the terminal device (such as a personal computer). However, it is understood that, embodiments of the program product are not limited thereto. The readable storage medium may be physical medium comprising or containing the program, and the program can be executed for being used by or in combination with an instruction execution system, an apparatus, or a device.

The program product can use any combination of one or more readable media. The readable medium may be a readable signal medium or a readable storage medium. The readable storage medium may be, for example, but not limited to, an electrical, magnetic, optical, electromagnetic, infrared, or semiconductor system, apparatus, or device, or may be a combination of any of the above. More specific examples of the readable storage medium may comprise, but not limited to, electrical connections with one or more wires, portable hard drive, hard drive, random access memory (RAM), read-only memory (ROM), erasable programmable read-only memory (EPROM or flash memory), optical fiber, compact hard disk read-only memory (CD-ROM), optical memory, magnetic memory, or any proper combinations of the above.

The computer-readable signal medium may comprise data signals in the baseband or data signals propagated as part of a carrier wave, and the readable program codes are carried in the signal medium. This propagated data signal can have many forms, including but not limited to, electromagnetic signals, optical signals, or any suitable combination of the above. The readable signal medium may also be any readable medium other than the readable storage medium, and the readable medium may send, propagate, or transmit a program for being used by or in combination with an instruction execution system, an apparatus, or a device. The codes contained in the readable signal medium may be transmitted by any suitable medium, including but not limited to wireless, wired, optical cable, radiofrequency (RF), etc., or may be transmitted by any suitable combination of the above.

The codes used to perform the operation of one or some embodiments of the instant disclosure can be written in any combination of one or more programming languages. The programming language may comprise object-oriented programming languages, such as Java, C++, etc., and the programing language may further comprise existing procedural programming languages, such as “C” language or similar programming languages. The codes may be entirely executed on the user's computing device, partly executed on the user's device, executed as a stand-alone software package partly executed on the user's computing device and partly executed on the remote computing device, or entirely executed on the remote computing device or on a server. In the case that the remote computing device is involved, the remote computing can be connected to the user computing device through any kind of networks, comprising local area network (LAN) or wide area network (WAN), or can be connected to the external computing device (for example, using an Internet service provider to connect through the Internet).

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A payment verification method comprising:
monitoring a voice command received by a voice-receiving device of an earphone when a payment channel between the earphone and a payment device paired to the earphone is opened;
extracting a voiceprint feature of a payment voice command in response to the payment voice command;
verifying the voiceprint feature to determine whether a user identity corresponding to the voiceprint feature matches a target user identity pre-stored in the earphone; and
transmitting a payment command to the payment device when the user identity matches the target user identity.

2. The payment verification method according to claim 1, wherein the payment channel is opened when any of following criteria meets:
a communication connection is established between the earphone and the payment device; or
a communication connection is established between the earphone and the payment device, wherein a preset operation of the earphone is triggered;
wherein the communication connection is a wired connection or a Bluetooth connection.

3. The payment verification method according to claim 1, wherein the step of monitoring the voice command received by the voice-receiving device of the earphone comprises:
performing a content recognition to the voice command when the voice-receiving device receives the voice command and determining whether a voice content of the voice command matches a target content; and
recognizing the voice command as the payment voice command when the voice content matches the target content.

4. The payment verification method according to claim 3, wherein before the step of determining whether the voice content of the voice command matches the target content, the payment verification method further comprises:
determining whether a voice-emitting device of the earphone already sends out a payment inquiry message or a payment verification message in a preset time duration before the voice-receiving device receives the voice command;
determining the payment inquiry message or the payment verification message sent out by the voice-emitting device as the target content when the voice-emitting device already sends out the payment inquiry message or the payment verification message in the preset time duration before the voice-receiving device receives the voice command; and
determining a preset payment keyword as the target content when the voice-emitting device does not already send out the payment inquiry message or the payment verification message in the preset time duration before the voice-receiving device receives the voice command.

5. The payment verification method according to claim 3, further comprising monitoring a vibration signal collected by a bone conduction sensor of the earphone;
wherein before performing the content recognition to the voice command, the payment verification method further comprises:
determining whether the vibration signal collected by the bone conduction sensor is synchronized with the voice command;
executing the step of performing the content recognition to the voice command when the vibration signal collected by the bone conduction sensor is synchronized with the voice command; and
sending out a notification message for indicating to input the voice command again by a voice-emitting device of the earphone when the vibration signal collected by the bone conduction sensor is not synchronized with the voice command.

6. The payment verification method according to claim 1, wherein after the step of transmitting the payment command to the payment device, the payment verification method further comprises:
sending out a first vibration signal by a bone conduction sensor at one of two sides of the earphone in response to a second-time verification command for indicating an abnormal transaction, and collecting a second vibration signal by a bone conduction sensor at the other side of the earphone, wherein the first vibration signal is transmitted by a user to be the second vibration signal;
verifying whether a vibration attenuation curve of the second vibration signal with respect to the first vibration signal matches the target user identity;
performing a payment by the payment device when the vibration attenuation curve of the second vibration signal with respect to the first vibration signal matches the target user identity; and
sending out a notification message for indicating that the payment is failed by a voice-emitting device of the earphone when the vibration attenuation curve of the second vibration signal with respect to the first vibration signal does not match the target user identity.

7. The payment verification method according to claim 1, wherein after the step of transmitting the payment command to the payment device, the payment verification method further comprises:
collecting a target physiological feature based on a trigger operation in response to a second-time verification command for indicating an abnormal transaction, wherein an imitability of the target physiological feature is less than an imitability of the voiceprint feature;
verifying the target physiological feature to determine whether the user identity corresponding to the target physiological feature matches the target user identity;
performing a payment by the payment device when the user identity corresponding to the target physiological feature matches the target user identity; and
sending out a notification message for indicating that the payment is failed by a voice-emitting device of the earphone when the user identity corresponding to the target physiological feature does not match the target user identity.

8. The payment verification method according to claim 7, wherein the step of collecting the target physiological feature based on the trigger operation comprises:
sending out the second-time verification command by the voice-emitting device of the earphone;
triggering the earphone or the payment device to collect the target physiological feature based on a type of the trigger operation in a preset waiting time when the earphone receives the trigger operation; and
sending out the notification message for indicating that the payment is failed by the voice-emitting device when the earphone does not receive the trigger operation or when the voice-receiving device receives a verification refusal command.

9. The payment verification method according to claim 8, wherein:
the target physiological feature collected by the earphone comprises a heartrate feature, the earphone stores a heartrate recognition model adapted to recognize the user identity based on the heartrate feature, and the earphone verifies the heartrate feature with the heartrate recognition model; and
the target physiological feature collected by the payment device comprises a facial feature, the payment device stores a facial recognition model adapted to recognize the user identity based on the facial feature, and the payment device verifies the facial feature with the facial recognition model.

10. The payment verification method according to claim 7, wherein after the step of performing the payment by the payment device, the payment verification method further comprises:
uploading a transaction data to a Blockchain and storing the transaction data to a transaction record corresponding to the target user identity, wherein the transaction data comprises the payment voice command, a verification result corresponding to the second-time verification command, a transaction time, and a transaction content.

11. The payment verification method according to claim 6, wherein after the step of performing the payment by the payment device, the payment verification method further comprises:
uploading a transaction data to a Blockchain and storing the transaction data to a transaction record corresponding to the target user identity, wherein the transaction data comprises the payment voice command, a verification result corresponding to the second-time verification command, a transaction time, and a transaction content.

12. The payment verification method according to claim 1, wherein after the step of transmitting the payment command to the payment device, the payment verification method further comprises:
determining whether the payment device is in a Mesh network, wherein the Mesh network comprises a plurality of the payment devices;
generating a to-be-paid record for each of the payment devices in the Mesh network when the payment device is in the Mesh network, wherein the to-be-paid record comprises a to-be-paid content and a to-be-paid amount;
recognizing the payment device and the to-be-paid record designated by a payment-designating command in response to the payment-designating command in the Mesh network; and
transmitting the to-be-paid record designated by the payment-designating command to the payment device designated by the payment-designating command to perform the payment, wherein the payment device designated by the payment-designating command is one or more of the payment devices in the Mesh network;
wherein the to-be-paid record designated by the payment-designating command is the to-be-paid record of one or more of the payment devices in the Mesh network.

13. The payment verification method according to claim 1, wherein the earphone stores a voiceprint recognition model adapted to recognize the user identity based on the voiceprint feature, and the earphone verifies the voiceprint feature with the voiceprint recognition model;
after the step of verifying the voiceprint feature, the payment verification method further comprises:
intercepting the payment command when the user identity corresponding to the voiceprint feature does not match the target user identity and sending out a notification message for indicating that a verification is failed by a voice-emitting device of the earphone; and
sending out a notification message for indicating to input the voice command again by the voice-emitting device of the earphone when the voiceprint feature or the user identity corresponding to the voiceprint feature is abnormal.

14. A payment verification system comprising:
a monitoring module adapted to monitor a voice command received by a voice-receiving device of an earphone when a payment channel between the earphone and a payment device paired to the earphone is opened;
a collecting module adapted to extract a voiceprint feature of a payment voice command in response to the payment voice command;
a verification module adapted to verify the voiceprint feature to determine whether a user identity corresponding to the voiceprint feature matches a target user identity pre-stored in the earphone; and
a communication module adapted to transmit a payment command to the payment device when the user identity corresponding to the voiceprint feature matches the target user identity.
